(19) United States
(12) Patent Application Publication
(10) Pub. No.: US 2006/0004688 A1
(43) Pub. Date: Jan. 5, 2006

(54) Systems and methods for integrating various processes

(76) Inventors: James Robert Scanlon, Middletown, CT (US); Andrew Back, Farmington, CT (US); JoAnn Mary Clauss, Bristol, CT (US); Mark Edward Dausch, Castleton, NY (US); Gary Paul Michaelis, Oakville, CT (US); Gary David Magnan, Issaquah, WA (US); Richard Allen Cornish, Terryville, CT (US); Stanley Thomas Mason, Hardy, VA (US); Madhusudana Rao Kurapati, Andhra Pradesh (IN); Syed Khader Mohiddin, Andhra Pradesh (IN); Srinivas Boyapati, Andhra Pradesh (IN)

Correspondence Address: PATRICK W. RASCHE;ARMSTRONG TEASDALE LLP, ONE METROPOLITAN SQUARE, SUITE 2600, ST. LOUIS, MO, 63102-2740, US

(21) Appl. No.: 10/884,095

(22) Filed: Jul. 2, 2004

(51) Int. Cl. G06F 17/30

(52) U.S. Cl. 707/1

(57) ABSTRACT

A method for integrating various processes is described. The method includes managing of data by a first business unit, where managing of data includes at least one of storing-the data within a data repository and editing the data. The method also includes automatically sending a notification from the first business unit to a second business unit after the first business unit has completed managing the data.

### BACKGROUND OF THE INVENTION

This invention relates generally to integration systems and processes and more particularly, to systems and methods for integrating various processes.

Many systems such as product data management (PDM), computer aided design (CAD), computer aided manufacturing (CAM) currently exist. The existing systems are used to create drawings, generate documents, and manage the documents and drawings. However, there is lack of co-ordination and interaction between the existing systems.

### BRIEF DESCRIPTION OF THE INVENTION

In one aspect, a method for integrating various processes is described. The method includes managing of data by a first business unit, where managing of data includes at least one of storing the data within a data repository and editing the data. The method also includes automatically sending a notification from the first business unit to a second business unit after the first business unit has completed managing the data.

In another aspect, a method for integrating various processes includes automatically downloading a master list when a user logs into a web-based user interface. The method also includes querying the master list by executing a logic module to connect the user to a first server providing at least one of a consumption of a lower bandwidth and a faster user interface response than that of remaining servers, and redirecting user requests to the first server.

In yet another aspect, a method for integrating various processes includes executing a first change request that passes a first document through a first series of life cycle states. The first change request is executed by a server. The method also includes executing a second change request that passes a second document through a second series of life cycle states, and combining the first and second change requests to generate a third change request that passes a third document through a third series of life cycle states.

In another aspect, a computer is described. The computer is configured to manage data by obtaining inputs from a first business unit within an organization, and automatically send a notification from the first business unit to a second business unit after the first business unit has completed managing the data.

In yet another aspect, a computer configured to automatically download a master list when a user logs into a web-based user interface is described. The computer is also configured to query the master list by executing a logic module to connect the user to a first server providing at least one of a consumption of a lower bandwidth and a faster user interface response than that of remaining servers, and redirect user requests to the first server.

In yet another aspect, a computer configured to execute a first change request that passes a first document through a first series of life cycle states is described. The computer is also configured to execute a second change request that passes a second document through a second series of life cycle states, and combine the first and second change requests to generate a third change request that passes a third document through a third series of life cycle states.

### BRIEF DESCRIPTION OF THE DRAWINGS

FIG. 1 is a block diagram of an embodiment of a system for integrating various processes.

FIG. 2 shows a detailed block diagram of another embodiment of a system for integrating various processes.

FIG. 3 shows an embodiment of a search screen generated by executing methods for integrating various processes.

FIG. 4 shows an embodiment of a view/modify screen on which a copy-out button is selected.

FIG. 5 shows an embodiment of a copy-out screen generated by executing the methods for integrating various processes.

FIG. 6 shows another embodiment of a view/modify screen on which a check-out button is selected.

FIG. 7 shows an embodiment of a check-out screen generated by executing the methods for integrating various processes.

FIG. 8 shows yet another embodiment of a view/modify screen on which a check-in button is selected.

FIG. 9 shows an embodiment of a check-in screen generated by executing the methods for integrating various processes.

FIG. 10 shows yet another embodiment of a view/modify screen on which a support info view block is located.

FIG. 11 shows another an embodiment of a view/modify screen on which a cancel check-out button is located.

FIG. 12 shows an embodiment of a cancel check-out screen generated by executing methods for integrating various processes.

FIG. 13 shows yet another an embodiment of a view/modify screen on which a content view button is selected.

FIG. 14 shows an embodiment of a select and view screen generated by executing the methods for integrating various processes.

FIG. 15 shows another embodiment of a view/modify screen on which a CR/CN/BR link is selected.

FIG. 16 is a block diagram of an embodiment of an application server located with the system of FIG. 2.

### DETAILED DESCRIPTION OF THE INVENTION

Described below are embodiments of systems and methods for integrating various processes. The systems and methods facilitate an integration of various types of management, such as, engineering or design management, manufacturing management, and marketing management, under a governing control of a change control management system (CMS), described below. As an example, the systems and methods facilitate a notification of and transmission of data corresponding to engineering or design work to a plurality of manufacturing divisions operated and controlled by a manufacturing business unit of an organization. The engineering work is work done by engineering or design divisions to design a part. The engineering divisions are divisions operated and controlled by an engineering business unit of the organization. Manufacturing work that occurs at the manufacturing divisions of the manufacturing business unit is tracked under the control of CMS in a manner that is similar to a manner in which the engineering work occurring at the engineering divisions of the organization is tracked under the control of CMS. The manufacturing work is work done to manufacture the part. CMS monitors and processes data changes for the various types of management. As an example, the systems and methods provide for an automatic update of documents, such as marketing documents, when engineering changes affecting the documents are completed. All documents include parts data, which is data related to a part, such as a screw, a nut, an AND gate, an OR gate, and a transistor.

Furthermore, CMS controls whether a current life cycle state of a document is advanced to a next life cycle current state and eventually to a final life cycle state indicating work completed. CMS provides an automatic notification from a division of a first business unit, such as a division of the engineering unit to a division of another business unit, such as a division of the manufacturing unit, when a life cycle state of a document managed by the division of the first business unit is advanced to the final life cycle state.

Moreover, CMS controls a change notice (CN) function executed within a type of division, such as the manufacturing and marketing divisions. The marketing divisions are operated and controlled by a marketing business unit of the organization. The marketing divisions market a part that is either designed by the engineering divisions or manufactured by the manufacturing divisions. A document is at an initial life cycle state within the CN function when divisions of the first business unit complete a data change. The data change is a change in the parts data. A document is advanced from the initial life cycle state within the CN function towards the final life cycle state within the CN function when divisions of a business unit electronically sign off on work completed at their individual sites. When a last division of a business unit completes its work for a data change, an electronic approval is sent to a division of another business unit, such as the marketing divisions, and a document is moved to the final life cycle state within the CN function. A transfer of a document to the final life cycle state within the CN function indicates that all work to be done by divisions within a business unit, such as the manufacturing divisions, for a data change is complete.

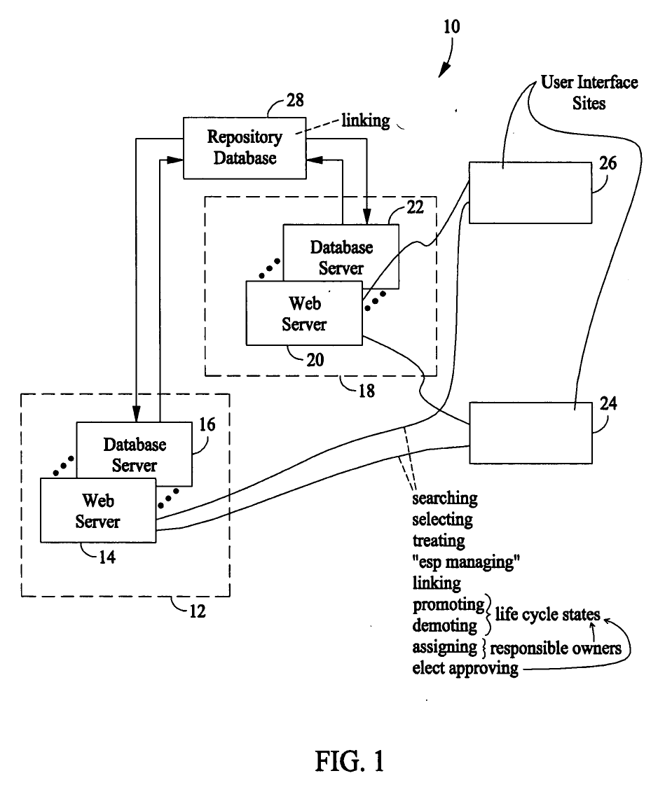

FIG. 1 is a block diagram of an embodiment of a system 10 for integrating various processes. System 10 includes a server site 12 that includes a web server 14 and a database server 16. System 10 further includes a server site 18 that includes a web server 20 and a database server 22. System 10 also includes user interface sites 24 and 26. System 10 further includes a repository database 28. User interfaces sites 24 and 26 include computers, including, for example, web-based personal computers (PCs) capable of accessing the web. User interface sites 24 and 26 are connected to any of server sites 12 and 18, potentially through the web. Server sites 12 and 18 are capable of reading data from and writing data to data repository database 28.

Repository database 28 includes product configuration data such as logic tables, master models, and configurations of a part. Repository database 28 further includes project data such as identification of project teams, schedules, and project documents. Repository database 28 also includes solids models such as CAD models, layouts, engineering drawings, and product structure data. Repository database 28 includes commercial information such as supplier and consumer information for various parts and products. Repository database 28 includes code and code control information such as source code, libraries, specifications, design documents, build documents, and archives.

User interface response time and bandwidth optimization is provided when user interface sites 24 or alternatively user interface site 26 acquire information from one of server sites 12 and 18. For example, when a user at user interface site 26 logs into system 10, user interface site 26 acquires information from one of server sites 12 and 18. The information that is acquired notifies one of the user interface sites 24 and 26 that by accessing data repository 28 through server site 12 instead of server site 18, the user optimizes user interface response or download time and bandwidth.

When the user at user interface site 26 logs into one of server sites 12 and 18, user interface site 26 automatically queries server site 12 or alternatively server site 18. User interface site 26 automatically queries by executing an applet, such as an applet written in Java. The applet is executed to search for a file. The applet is also executed to find the file and automatically download the file from one of server sites 12 and 18 to user interface site 26. The file includes a master list. A location from which the file is downloaded into user interface site 26 is based on the user's login location. For example, if the user at user interface site 26 logs into server site 12, the file is downloaded from server site 12. As another example, if the user at user interface site 26 logs into server site 18, the file is downloaded from server site 18. The applet queries the master list by applying a light weight directory access protocol (LDAP) to determine if there are multiple server sites that the user can access, and selects an optimal server site, such as server site 12. The optimal server site is a server site that provides a quicker user interface response time obtained by comparing user interface response times of server sites 12 and 18. Alternatively, the optimal server site is a server site that consumes less bandwidth obtained by comparing bandwidths consumed by communications between one of server sites 12 and 18 and user interface site 26. For a remaining portion of the user's login session, the applet redirects user requests for retrieval and storage of data to the optimal server site.

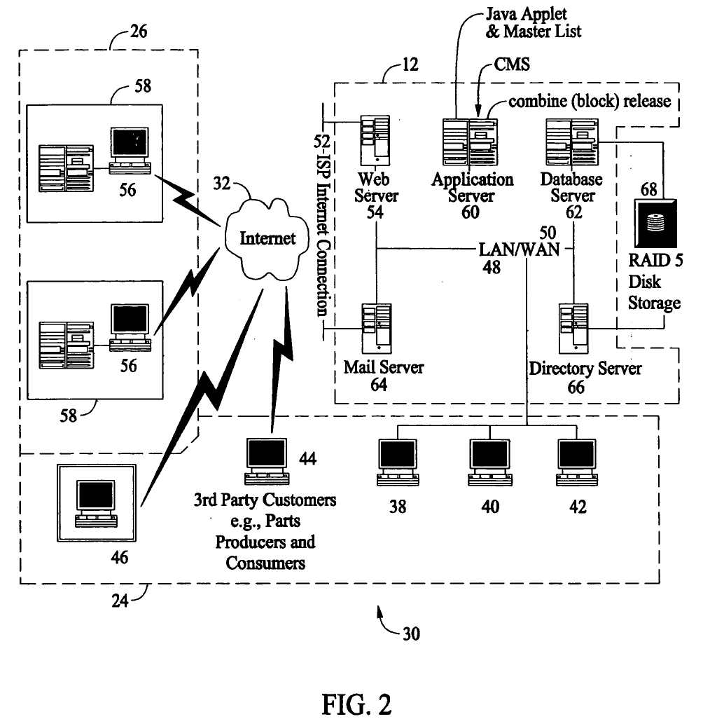

FIG. 2 shows a detailed block diagram of an embodiment of a system 30 for integrating various processes. System 30 includes user interface sites 24 and 26, and server site 12. Internet web 32 is used to interconnect any of a plurality of user interface sites 24 and 26 to a plurality of server sites, for example, server site 12. Computers 38, 40, 42, 44, and 46 of user interface site 24 are connected to server site 12 via web 32, or potentially via more direct LAN/WAN connections, as exemplified by a LAN connection 48 and a WAN connection 50. If connected via web 32, internet service provider (ISP) connections 52 provide access from computers 38, 40, 42, 44, and 46 of user interface site 24 to web servers, such as for example, web server 54, of server site 12. Web server 54 accesses data of legacy systems, such as an Oracle™ database, a Sybase™ database, DB2™, or Microsoft™ Access. Computers 56 of user interface site 26 are connected to server site 12 in a similar manner as computers 38, 40, 42, 44, and 46 of user interface site 24 are connected to server site 12.

Computers 56 are a part of a manufacturing resource planning (MRP) system, such as each of MRP systems 58. As an example, computers 56 of user interface site 26 are located within the manufacturing divisions. In the example, computers 38, 40, 42, 44, and 46 of user interface site 24 are located within the engineering divisions and used by engineers, customers of the engineering divisions, and others with permissions for access to system 30. Server site 12 includes an application server 60, a database server 62, a mail server 64, and a directory server 66. Any of servers 54, 60, 64, and 66 are connected to a data repository 68 via database server 62. The repository data stored within data repository 68 is the same as the repository data stored within repository database 28.

Any of servers 54, 60, 62, 64, and 66 execute the methods for integrating various processes. The methods for integrating various processes include performing document management functions, which include searching for and selecting the repository data from data repository 68, creating the repository data for optional storage into data repository 68, editing the repository data, and retrieving the repository data from data repository 68. Moreover, the document management functions include linking the repository data within data repository 68, promoting the current life cycle state of a document to the next life cycle state when a data change occurs within the document, demoting the current life cycle state of the document to a previous life cycle state when a data change occurs within the document, assigning responsible entities to the document at the previous, current, and next life cycle states when making a data change within the document, notifying appropriate parties electronically when promoting or alternatively demoting a life cycle state of a document, and receiving electronic approval from responsible entities when promoting or alternatively demoting a life cycle state of a document.

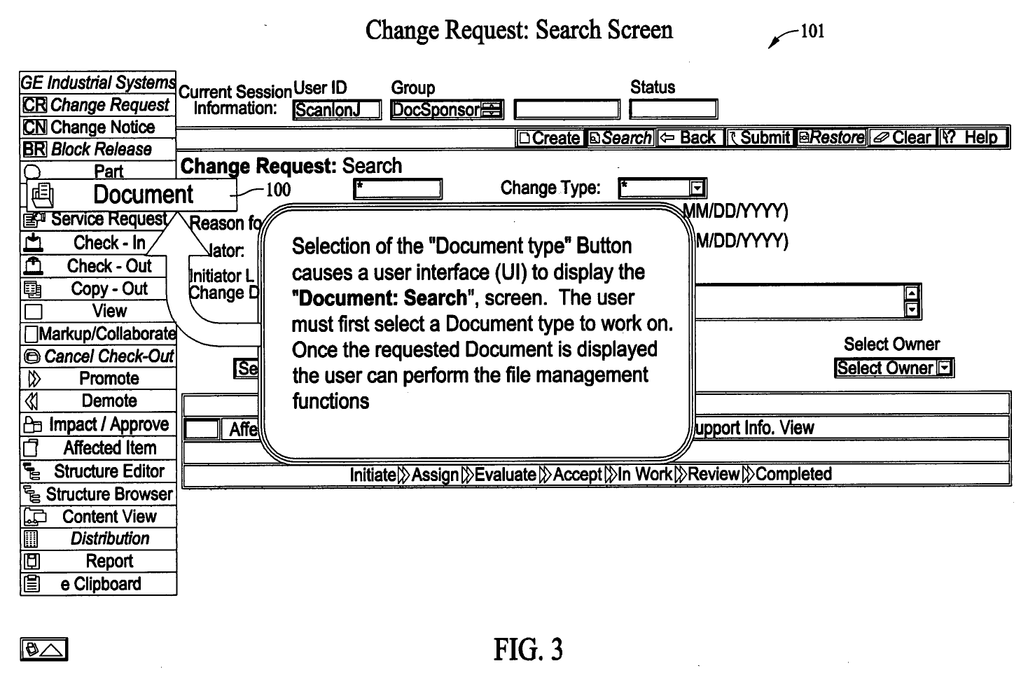

The document management functions also include, but are not limited to, a selection, by the user, of a document type of a document to work on, copying out the document, checking out the document, checking in the document, canceling checking out, and viewing content of the document, all of which are described below. The document type is selected by selecting a document button 100 on a search screen 101, shown in FIG. 3. When document button 100 is selected, the user selects documents that are linked to the document type and that are to be copied out to any of computers 38, 40, 42, 44, 46, 56 from data repository 68. When documents linked to the document type are copied out and displayed to the user, the document management functions are performed.

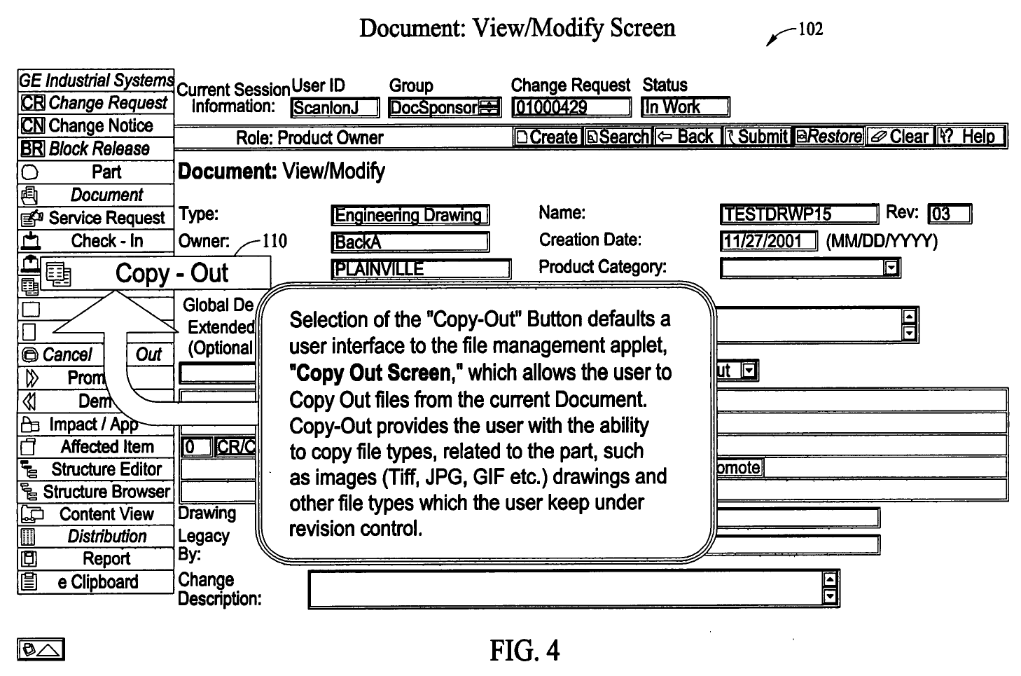

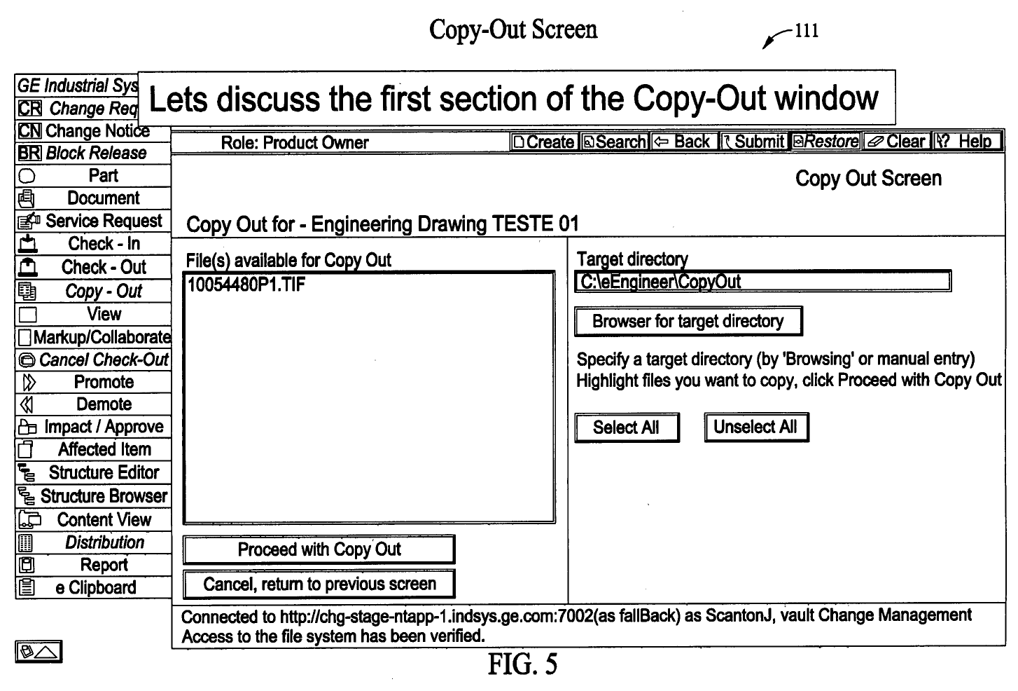

As shown in FIG. 4, when the user selects a view/modify screen 102 a copy-out button 110, a copy-out screen 111, shown in FIG. 5, is displayed to the user. Once the user selects copy-out button 110, a copy-out applet launches to copy out documents from data repository 68 to any of computers 38, 40, 42, 44, 46, 56. The user selects documents listed on copy-out screen 111 to copy out the documents. In one embodiment, copy out is performed to obtain a template of data and the template of data is used to create data. In another embodiment, documents copied out by the user are modified by the user. Any of servers 54, 60, 62, 64, and 66 within server site 12 return the user from copy-out screen 111 to view/modify screen 102 once copy out is complete.

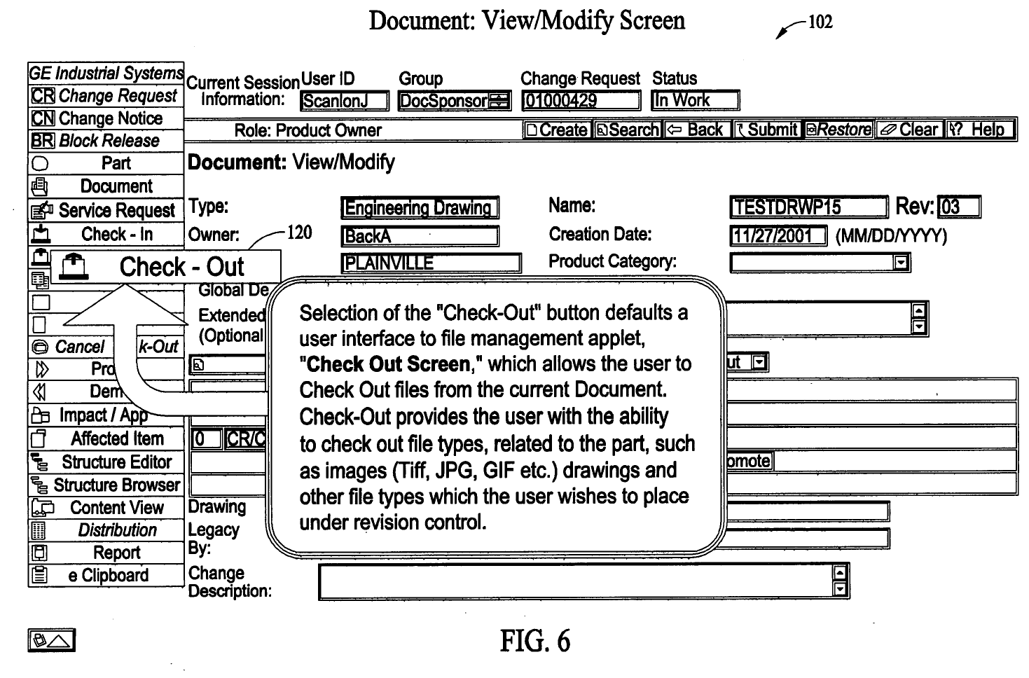

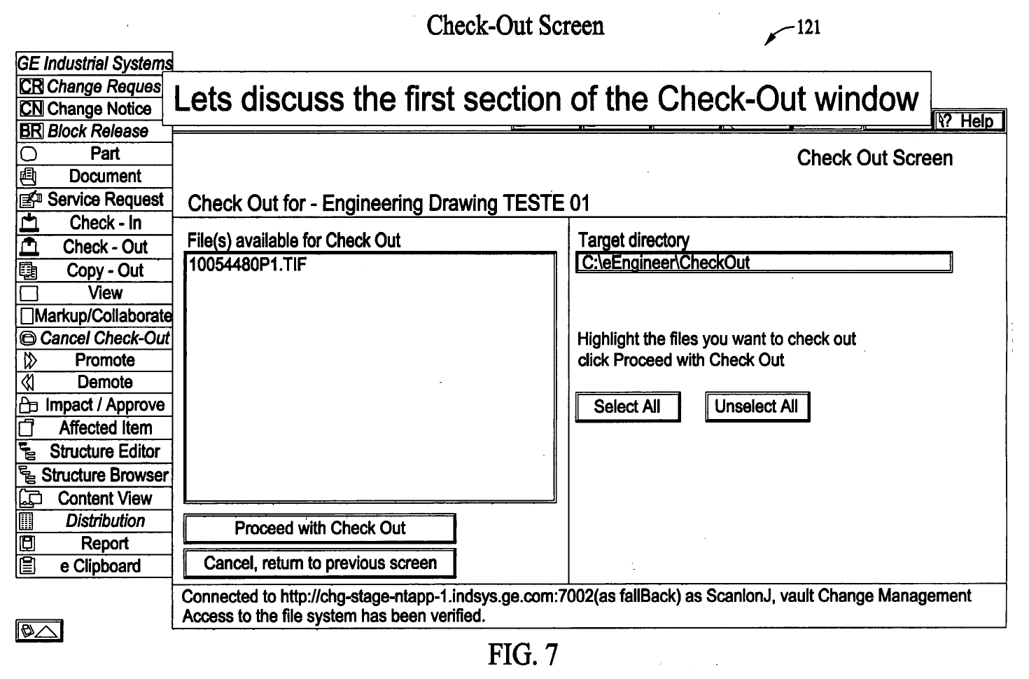

As shown in FIG. 6, the user selects a check-out button 120 on view/modify screen 102 to check-out documents linked to the document type. Various document types, such as images (e.g. TIF, JPG, and GIF), drawings, and other document types, which the user desires to place under CMS control, which is described below, are checked out by selecting check-out button 120. Selecting check-out button 120 generates a check-out screen 121, which is shown in FIG. 7, on which the user selects documents that the user desires to check out from data repository 68. When check-out button 120 is selected, a check-out applet launches for selecting and checking-out documents linked to the document type. Documents are checked out to a specific location on a local hard drive of the user interface sites 24 and 26. The user accesses the documents from the local hard drive and makes changes to the documents. Any of servers 54, 60, 62, 64, and 66 within server site 12 return the user from check-out screen 121 to view/modify screen 102 once check-out is complete.

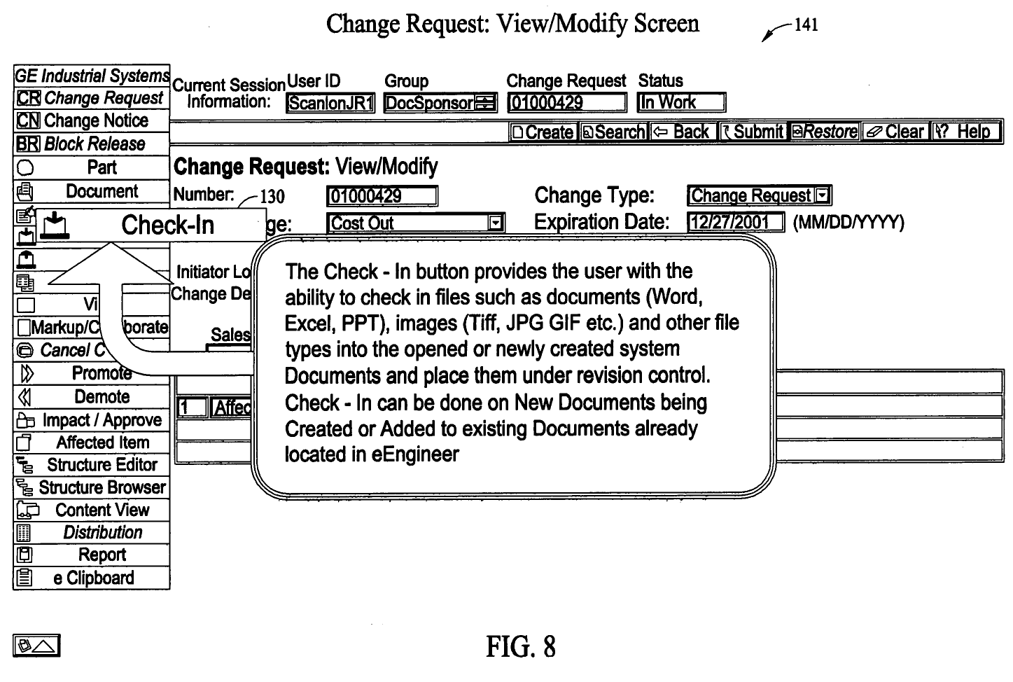

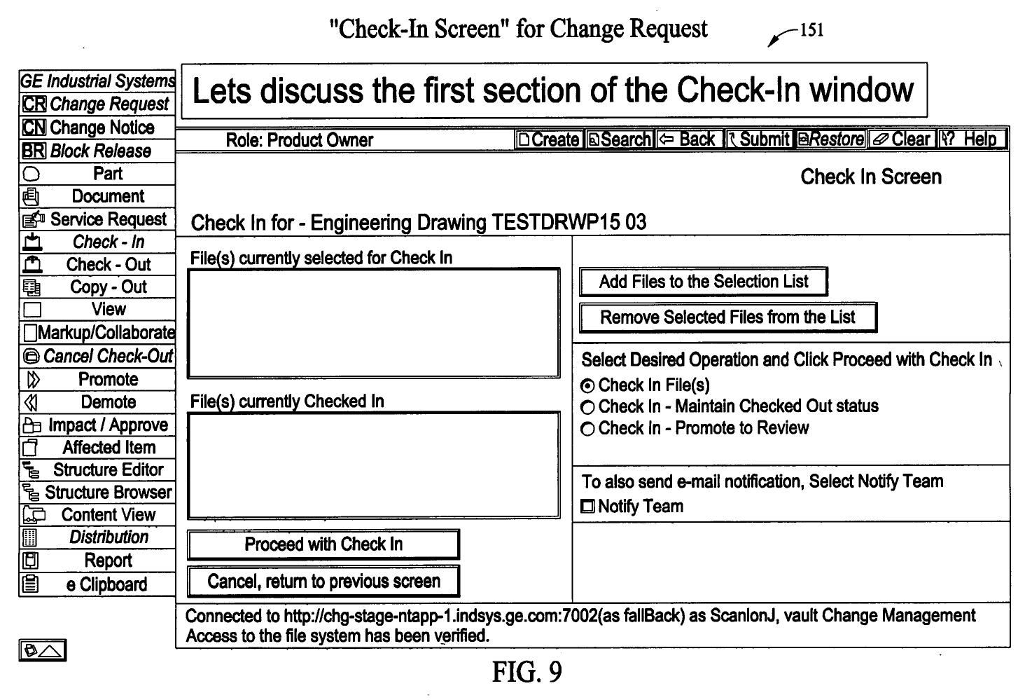

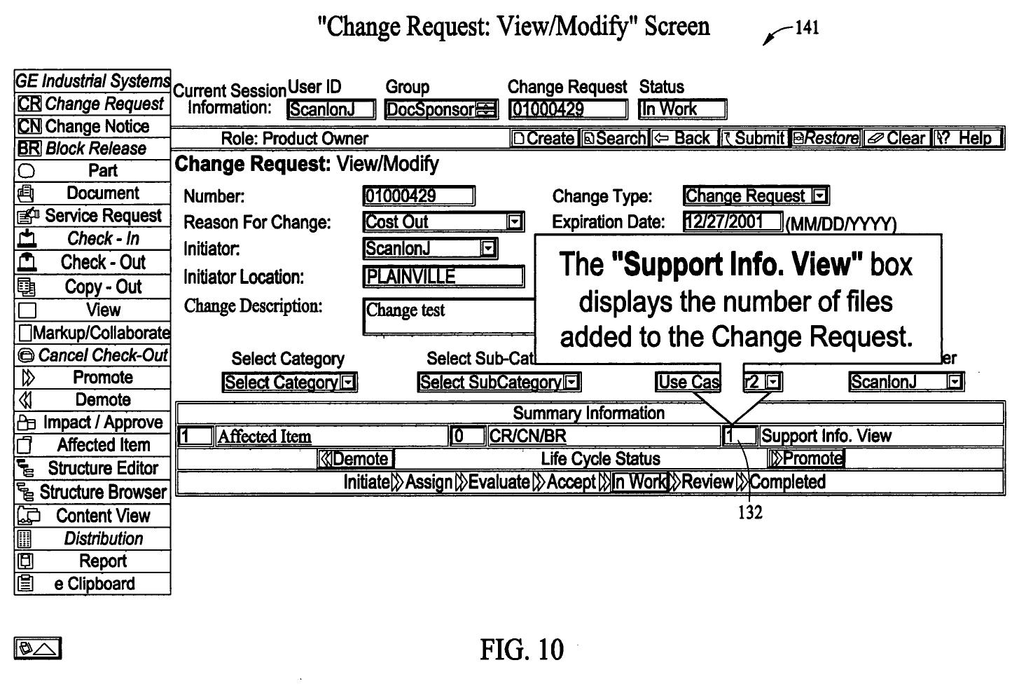

The user selects a check-in button 130 on a view/modify screen 141, shown in FIG. 8, to check-in a document that is checked out. When check-in button 130 is selected, a check-in screen 151, shown in FIG. 9, is generated on which the user selects documents that the user desires to check into data repository 68. When check-in button 130 is selected, an applet executes to check-in a document. In one embodiment, when check-in button 130 is selected, the user is provided with various options besides checking in a document, such as, checking in the document while simultaneously maintaining a state of the document to other users as being checked out and checking in the document with a simultaneous promotion of a state of the document type to a review state. When checking in a document while simultaneously maintaining a state to other users as being checked out, a notify team option becomes available and the user can select the notify team option to send a notification that the document is checked out to other users within the team. Any of servers 54, 60, 62, 64, and 66 within server site 12 return the user from check-in screen 151 to view/modify screen 141 once check-in is complete. After a document is checked in, a support info view block 132, shown on view/modify screen 141 of FIG. 10, is updated to display a number of documents added to a change request (CR), which includes a series of life cycle states undergone by a document when the document is being managed by divisions of a business unit. A CR is a request for a data change within a document.

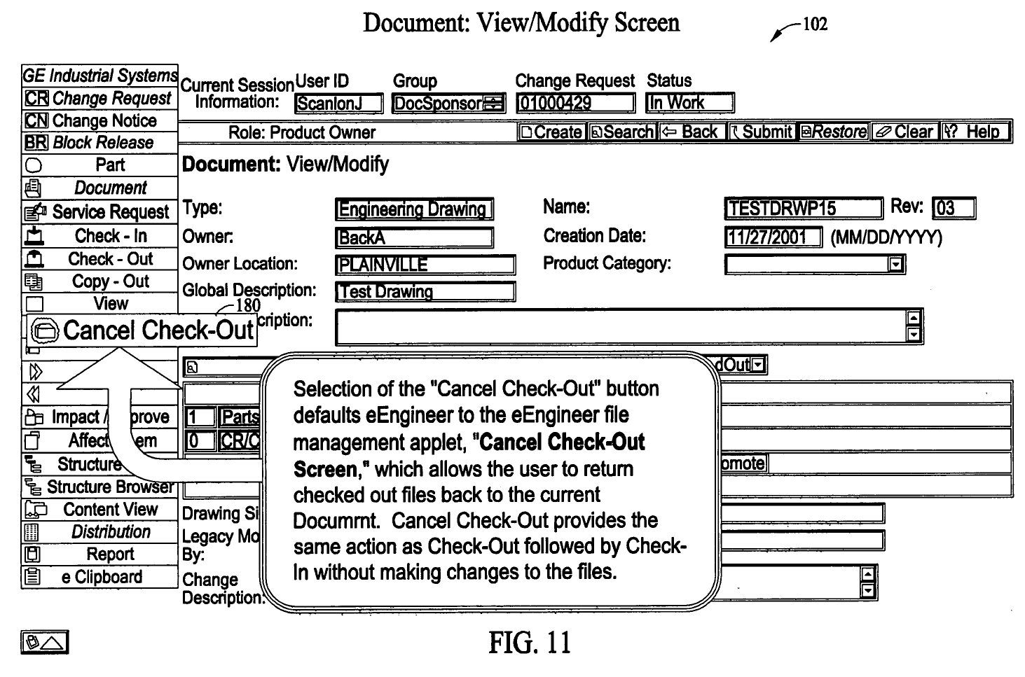

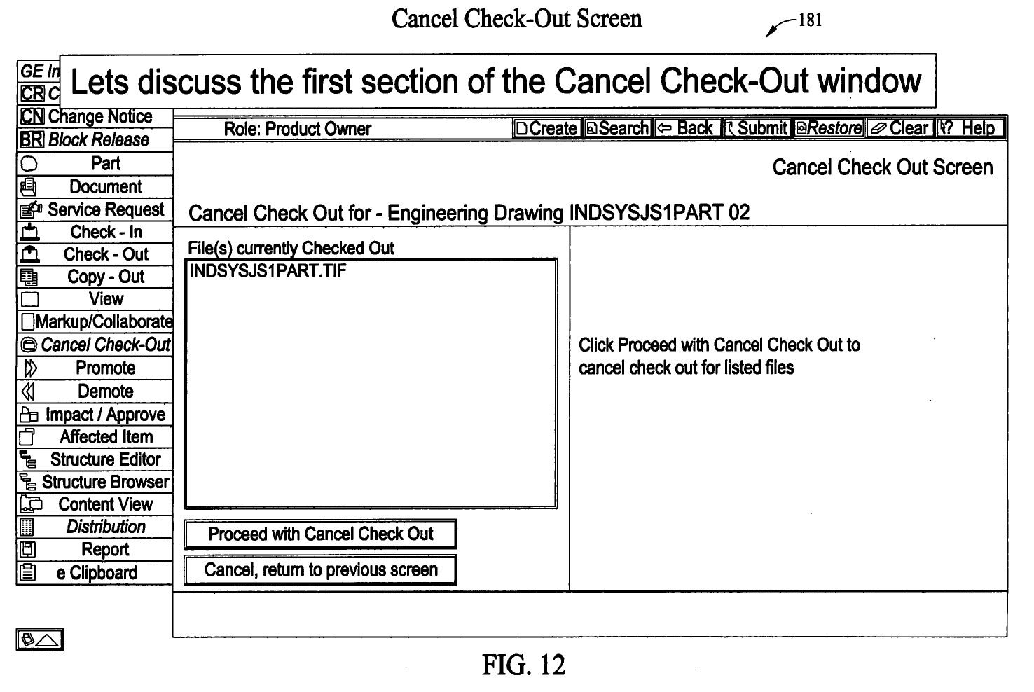

If the user desires to cancel a check-out that is in progress under CMS control, as shown in FIG. 11, the user selects a cancel check-out button 180 on view/modify screen 102. When cancel check-out button 180 is selected, a cancel check-out screen 181, shown in FIG. 12, is generated. The user selects on cancel check-out screen 181 a document that the user does not desire to change. Cancel check-out provides an action in which a check-out is followed by a check-in without making changes to the document that is checked out. Any of servers 54, 60, 62, 64, and 66 within server site 12 return the user from cancel check-out screen 181 to view/modify screen 102 once cancel check-out is complete.

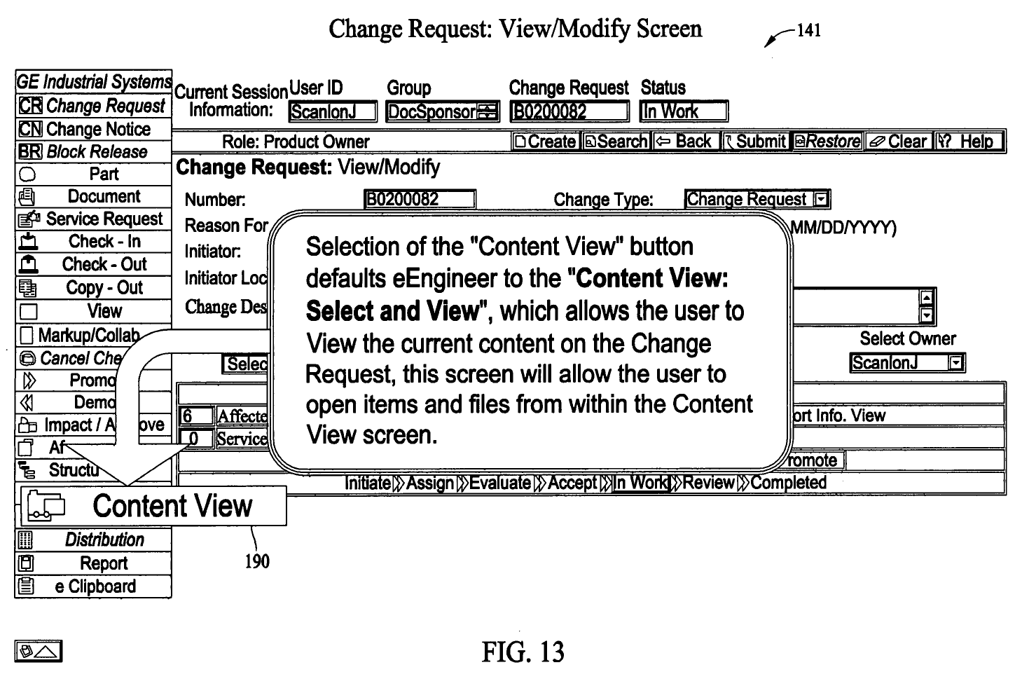

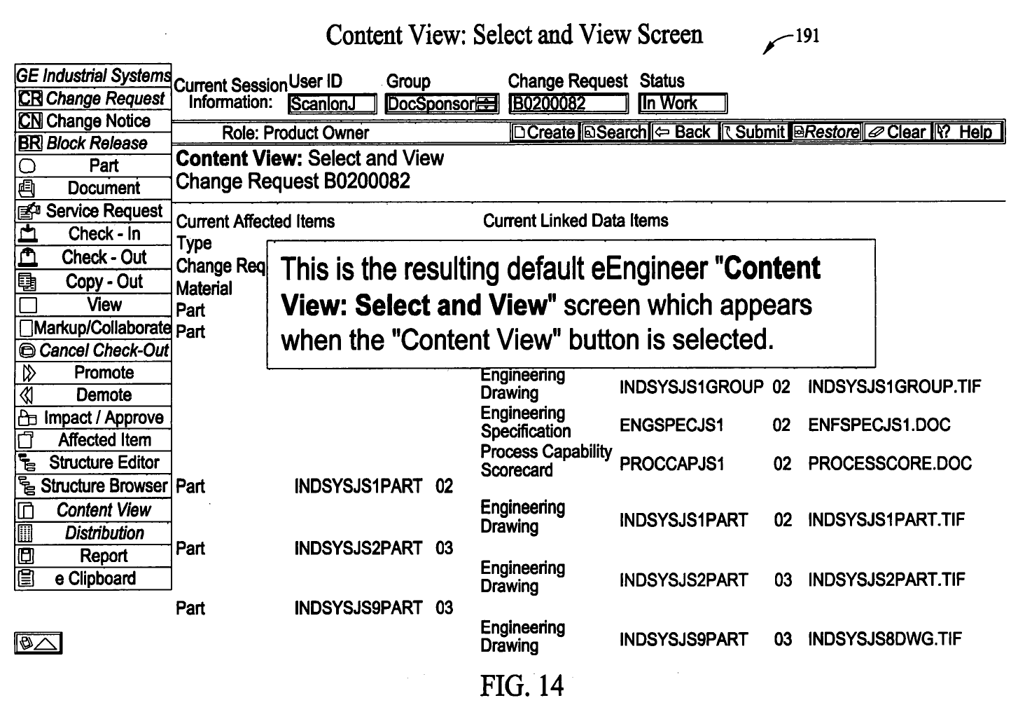

As shown in FIG. 13, when a content view button 190 is selected on view/modify screen 141, a select and view screen 191 is generated. Select and view screen 191 is shown in FIG. 14. The user views existing content or data on select and view screen 191, and opens documents listed on select and view screen 191.

It is noted that in one embodiment, any of the above described document management functions are performed on a document under CMS control. When the document management functions are performed on a document under CMS control, the document management functions are performed on the document that passes through a series of life cycle states. In an alternative embodiment, any of the above-described document management functions are performed on a document outside of CMS control. For example, a copy out of a document is performed without CMS control.

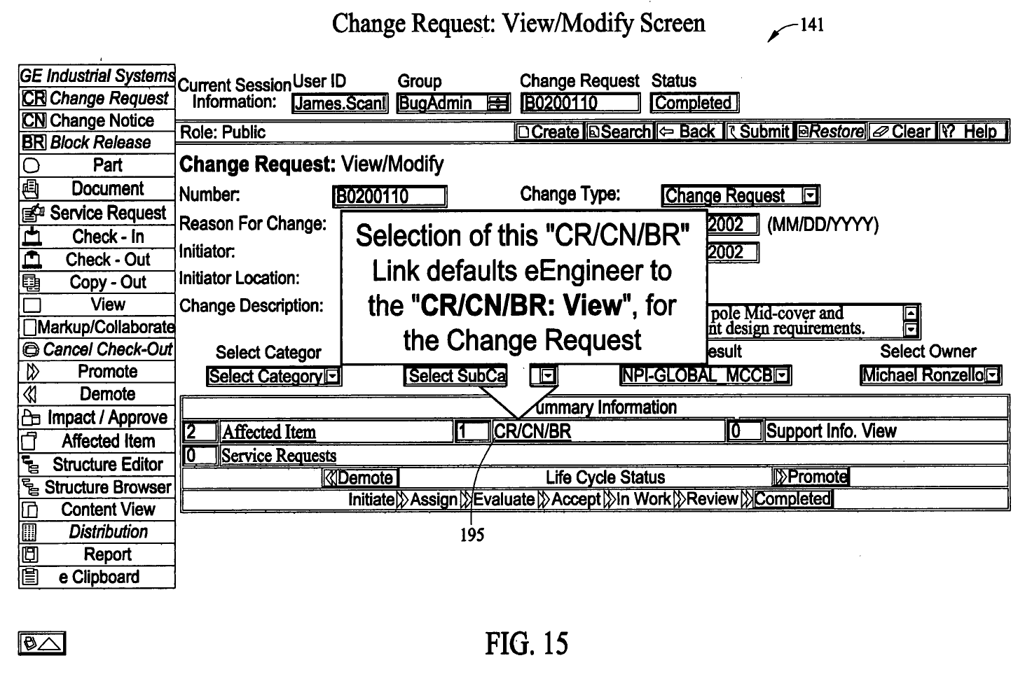

CMS includes CR/CN/block request (CR/CN/BR) functions. CMS tracks a data change made by a type of division. The CR/CN/BR functions are accessed when the user selects a CR/CN/BR link 195 on view modify screen 141 shown in FIG. 15.

Execution of the CR function creates the parts data within a document, adds the parts data to the document, searches the parts data from the document, deletes the parts data from the document, copies out and facilitates display of documents, assigns responsible entities for electronically approving a promotion of the current life cycle state of a document to the next life cycle state, assigns responsible entities for electronically approving a demotion of the current life cycle state of a document to the previous life cycle state, and notifies appropriate parties electronically when promoting or demoting a life cycle state of a document. Divisions of any one of the types described above execute the CR function.

When the CN function is executed, there is an automatic integration and synchronization of work, such as the engineering work, related to a data change and performed by divisions within the first business unit with work, such as the manufacturing and marketing work, related to a data change and performed by divisions of another type of business unit within the organization. The marketing work is work done by the marketing divisions of the organization. When work, such as the engineering work, done by divisions of the first business unit is completed for a part, a signal is generated to promote a document to the final life cycle state within the CR function, the CN fimction is initiated, a life cycle state of the document is set to the initial life cycle state within the CN function, and a CN request is sent to divisions, such as the manufacturing and marketing divisions, of another business unit that are being impacted by a data change. The CN request is sent electronically via mail server 64. The CN function that is initiated lists documents to be processed by divisions of a business unit in formats customized to be acceptable to the divisions. As an example, the CN function that is initiated lists documents to be processed by the manufacturing divisions in formats customized to be acceptable to MRP system 58 at each manufacturing division receiving the CN request.

When the CN request is received by divisions, such as the manufacturing and the marketing divisions, of a business unit, one of the divisions begins making a data change. As each impacted division completes work required for a data change, the division moves the current life cycle state of a document managed by the CN function to the next current life cycle state within the CN function. When a last division of a business unit completes work incorporating a data change within a document, the last division moves the document to the final life cycle state within the CN function. Promoting a document to the final life cycle state within the CN function indicates that work is completed at all affected divisions of a business unit.

In one embodiment, when the CN request is received by the manufacturing divisions of the manufacturing business unit, one of the manufacturing divisions uses MRP system 58 to begin the manufacturing work incorporating a data change. As each impacted manufacturing division of the manufacturing business unit completes the manufacturing work incorporating a data change, the manufacturing division moves the current life cycle state of a document managed by the CN function to the next current life cycle state within the CN function. When a last manufacturing division of the manufacturing business unit completes the manufacturing work required for a data change, the last manufacturing division moves a document to the final life cycle state within the CN function. Promoting a document to the final life cycle state within the CN function indicates that the manufacturing work is completed at all affected manufacturing divisions of the manufacturing business unit.

The CN function is similar to the CR function except that the CR function relates to a division of a business unit that is different than a business unit to which the CN function relates. As an example, the CN function is similar to the CR function except that the CR function is under the control of the engineering divisions and the CN function is under the control of the manufacturing divisions. User interface screens, such as view/modify screen 141, generated by executing the CR function are reused when executing CN function. The reuse creates life cycle states for monitoring work done by divisions, such as the manufacturing divisions of a business unit. The CR and CN functions are similar. For example, promotion of life cycle states, demotion of life cycle states, electronic approvals when a life cycle state of a document changes, and electronic notification of promotion of life cycle states function similarly within the CR and CN functions.

When the BR function is executed, multiple CR functions are grouped into one CR function. In one embodiment, the multiple CR functions affect the same part and potentially interact with each other. The grouping of the multiple CR functions into one CR function facilitates combined testing and verification of the same part managed by the multiple CR functions. A group of the multiple CR functions initiates a CN function in a similar manner as the CR function initiates the CN function when a document under control of the CR function is promoted to the final life cycle state.

In one embodiment, a first CR function is executed that passes a first document through a first series of life cycle states. The first document includes information regarding a first aspect of a part. A second CR function is also executed that passes a second document through a second series of life cycle states. The second document includes information regarding a second aspect of a part. The first and the second CR functions are combined to generate a third CR function that passes a third document through a third series of life cycle states. The third document includes information regarding both the first and the second aspects and that is generated by modifying information within the first and the second documents.

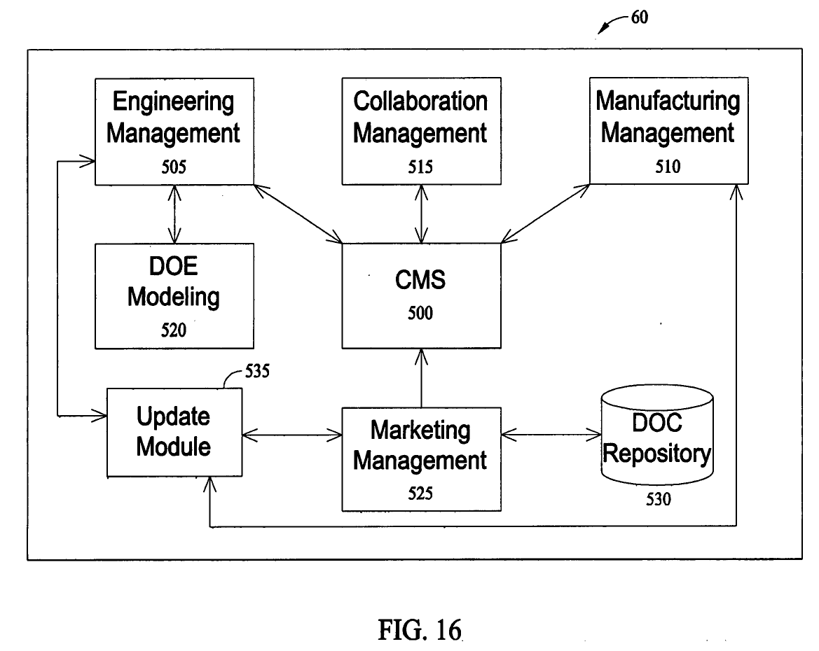

FIG. 16 is a block diagram of an embodiment of application server 60. Application server 60 includes and executes a CMS module 500, an engineering or design management module 505, a manufacturing management module 510, a collaboration management module 515, a design of experiments (DOE) module 520, a marketing module 525 coupled to a document repository 530, and an update module 535. Marketing module 525 accesses documents from and stores documents within document repository 530. In an alternative embodiment, marketing management module 525 uses data repository 68 to store and retrieve the repository data.

Engineering management module 505 is a code that is executed by the engineering divisions to design a part, manufacturing management module 510 is a code that is executed by the manufacturing divisions to manufacture a part, and marketing management module 525 is a code that is executed by the marketing divisions to market a part. The CR, CN, and BR functions described above are implemented within CMS module 500. As an example, CMS module 500 includes functions such as sending a notification to appropriate parties when promoting a life cycle state of a document from the current life cycle state to the next current life cycle state or alternatively when demoting the current life cycle state to the previous life cycle state.

Mail server 64 executes functions stored within CMS module 500 to automatically send notifications, such as an e-mail notice, when a life cycle state of a document is changed. CMS module 500 automatically sends notifications to manufacturing management module 510 when the engineering divisions have completed making a data change and automatically sends notification to the marketing divisions within the organization when the manufacturing divisions have completed making a data change. In an alternative embodiment, CMS module 500 automatically sends notifications to the marketing divisions when the engineering divisions have finished making a data change.

Collaboration management module 515 includes functions for collaborating between multiple users via a web-based user interface. The collaboration is between multiple users within divisions of a business unit. For example, users of the engineering divisions collaborate to design a part. As another example, users of the manufacturing divisions collaborate to manufacture a part. DOE modeling module 520 includes functions for an experimental design of the part. The experimental design is obtained for predictive behavior of a part and early issue or problem detection of the part.

Update module 535 includes functions for updating documents, such as marketing, manufacturing, and engineering documents, when divisions, such as the engineering divisions, of a business unit have completed making changes to the parts data. Update module 535 automatically sends a notification, such as e-mail notice, from divisions of the first business unit to divisions of another business unit when changes to the parts data are completed by divisions of the first business unit. As an example, an e-mail notice is sent from the engineering divisions, the manufacturing divisions, or alternatively the marketing divisions within the organization. When a notification is received by the user from update module 535, information regarding changes to the parts data that occurred within divisions of a business unit and a document that is to be updated is provided to the user by update module 535. Changes to the parts data and a document that is to be updated are sent separately from or alternatively as attachments with a notification provided to the user by update module 535. When the user receives a document that is to be updated, the user manually updates the document by making a data change.

Update module 535 includes functions for automatically updating a document received by a division of a business unit when divisions of another business unit has completed making a data change within a document. As an example, update module 535 includes functions for automatically updating a document managed by the manufacturing division when the engineering divisions have completed making a data change to a document managed by the engineering divisions. Update module 535, when notified, for instance, by the e-mail notice, automatically executes to replace text within a document with updated text. As an example, update module 535 automatically replaces the text with the updated text by linking the text within a document generated by divisions of a business unit with the updated text within a document generated by divisions of another business unit. The updated text is manually created. In addition, update module 535 customizes a format of a document to be updated by update module 535 based on formats acceptable to a division of a business unit to which the document is sent. Moreover, update module 535 customizes a format of a notification sent from divisions of the first business unit to divisions of another business unit when changes to the parts data are completed by divisions of the first business unit. A format of a notification is customized based on formats acceptable to a type of division of a business unit to which the notification is sent.

Marketing management module 525 creates various types of document templates used to present marketing documents. Examples of document templates include a field service report template, a presentation template, an article reprint template, a technical guide template, a cross reference template, a specifications template, a guideform specifications template, a high resolution image template, a low resolution image template, a promotional brochure template, a presentation template, a press release template, a published article template, a promotional video template, a question and answer template, a white paper template, a customer application brief template, an electronic document template, a merchandising display template, a service advice template, a catalog template, and a material safety data sheet template.

The user with the aid of marketing management module 525 defines a document template with its associated formatting and style. Once the document template is created, the document template is used to create the document type. When creating the document type, various text areas within a document of the document type is linked by update module 535 with text in documents processed by the engineering or the manufacturing divisions. When various text areas within a document of the document type is linked with text in documents processed by the engineering or the manufacturing divisions, changing documents processed by the engineering or the manufacturing divisions results in an automatic update of text within the document type.

It is noted that the term server or computer broadly refers to processors, microcontrollers, microcomputers, programmable logic controllers, application specific integrated circuits, and other programmable circuits, and these terms are used interchangeably herein. It is also noted that in an alternative embodiment, CMS module 500 manipulates versions of a document instead of the document. For instance, CMS module 500 promotes a particular version of a document through life cycle states.

It is also noted that in an alternative embodiment, the methods for integrating various processes are performed on an assembly of parts instead of a part. For example, when the BR function is executed, a CR function affecting data describing a first part within an assembly and a CR function affecting data describing a second part within the assembly are combined into one CR. The grouping of multiple CR functions into one CR function facilitates combined testing and verification of the assembly managed by the multiple CR functions. As another example, collaboration management module 515 includes functions for collaborating between multiple users on a design of an assembly of parts via a web-based user interface.

In an alternative embodiment, the engineering divisions, marketing divisions, and the manufacturing divisions are located in separate organizations. Moreover, in yet another alternative embodiment, the methods for integrating various processes are applied between divisions of various business units, such as the marketing divisions of the marketing business unit and human resources divisions of a human resources business unit within the organization. Furthermore, in still another alternative embodiment, the document templates are created for documents, such as resumes, within other divisions, such as a human resources division, of the organization.

While the invention has been described in terms of various specific embodiments, those skilled in the art will recognize that the invention can be practiced with modification within the spirit and scope of the claims.

What is claimed is:

1. A method for integrating various processes comprising:
managing of data by a first business unit, wherein said managing of data includes at least one of storing the data within a data repository and editing the data; and
automatically sending a notification from the first business unit to a second business unit after the first business unit has completed managing the data.

2. A method in accordance with claim 1 wherein said managing data comprises:
initiating a monitoring of a data change by establishing a sequence of life cycle states, beginning with an initial state and ending with a final state; and
completing the monitoring of the data change by advancing a current state through the sequence of life cycle states from the initial state to the final state.

3. A method in accordance with claim 1 further comprising:
initializing a document to an initial state within the second business unit when sending the notification; and
advancing the document to the final state within the second business unit when the second business unit electronically provides approval after a completion of work on the document by the second business unit.

4. A method in accordance with claim 1 wherein said automatically sending comprises automatically transmitting the notification via the electronic web.

5. A method in accordance with claim 1 further comprising converting the notification to a format acceptable to the second business unit.

6. A method in accordance with claim 1 wherein said automatically sending comprises automatically sending documents as attachments to the notification.

7. A method in accordance with claim 1 further comprising automatically updating a first document created by the second business unit when a second document created by the first business unit is updated.

8. A method in accordance with claim 1 further comprising:
executing a first change request that passes a first document through a first series of life cycle states, wherein the first change request is executed within one of the first and second business units;
executing a second change request that passes a second document through a second series of life cycle states; and
combining the first and second change requests to generate a third change request that passes a third document through a third series of life cycle states.

9. A method in accordance with claim 1 further comprising:
automatically downloading a master list when a user within one of the first and second business units logs into a web-based user interface;
querying the master list by executing a logic module to connect the user to a first server providing at least one of a consumption of a lower bandwidth and a faster user interface response than that of remaining servers; and
redirecting user requests to the first server.

10. A method in accordance with claim 9 wherein the logic module is a JAVA applet.

11. A method in accordance with claim 9 wherein said automatically downloading a master list comprises automatically downloading the master list via a web server to the web-based user interface.

12. A method in accordance with claim 9 wherein said querying the master list is performed by executing a light weight directory access protocol (LDAP).

13. A method in accordance with claim 1 wherein said managing of data comprises copying out the data from a data repository, checking out the data from the data repository, canceling the checking out of the data, checking in the data into the data repository, viewing the data, and deleting the data.

14. A method for integrating various processes comprising:
automatically downloading a master list when a user logs into a web-based user interface;
querying the master list by executing a logic module to connect the user to a first server providing at least one of a consumption of a lower bandwidth and a faster user interface response than that of remaining servers; and
redirecting user requests to the first server.

15. A method in accordance with claim 14 wherein the logic module is a JAVA applet.

16. A method in accordance with claim 14 wherein said automatically downloading a master list comprises downloading the master list via a web server to the web-based user interface.

17. A method in accordance with claim 14 wherein said querying the master list is performed by executing a light weight directory access protocol (LDAP).

18. A method for integrating various processes, said method comprising:
executing a first change request that passes a first document through a first series of life cycle states, the first change request executed by a server;
executing a second change request that passes a second document through a second series of life cycle states; and
combining the first and second change requests to generate a third change request that passes a third document through a third series of life cycle states.

19. A method in accordance with claim 18 wherein the first, second, and third change requests include requests for a change to data describing one of a part and an assembly of parts.

20. A method in accordance with claim 18 wherein each of said first, second, and third series include an initial state and a final state.

21. A computer configured to:
manage data by obtaining inputs from a first business unit within an organization; and
automatically send a notification from the first business unit to a second business unit after the first business unit has completed managing the data.

22. A computer in accordance with claim 21 wherein to manage data said computer configured to:
initiate a monitoring of a data change by establishing a sequence of life cycle states, beginning with an initial state and ending with a final state; and
complete the monitoring of the data change by advancing a current state through the sequence of life cycle states from the initial state to the final state.

23. A computer in accordance with claim 22 further configured to:
initialize a document to an initial state within the second business unit when sending the notification; and
advance the document to the final state within the second business unit when the second business unit electronically provides approval after a completion of work on the document by the second business unit.

24. A computer in accordance with claim 21 wherein to automatically send a notification said computer configured to automatically transmit the notification via the electronic web.

25. A computer in accordance with claim 21 further configured to convert the notification to a format acceptable to the second business unit.

26. A computer in accordance with claim 21 wherein to automatically send a notification said computer configured to automatically transmit documents as attachments to the notification.

27. A computer in accordance with claim 21 further configured to automatically update a first document created by the second business unit when a second document created by the first business unit is updated.

28. A computer in accordance with claim 21 further configured to:
execute a first change request that passes a first document through a first series of life cycle states, wherein the first change request is executed within one of the first and second business units;
execute a second change request that passes a second document through a second series of life cycle states; and
combine the first and second change requests to generate a third change request that passes a third document through a third series of life cycle states.

29. A computer in accordance with claim 28 further configured to:
automatically download a master list when a user within one of the first and second business units logs into a web-based user interface;
query the master list by executing a logic module to connect the user to a first server providing at least one of a consumption of a lower bandwidth and a faster user interface response than that of remaining servers; and
redirect user requests to the first server.

30. A computer in accordance with claim 29 wherein the logic module is a JAVA applet.

31. A computer in accordance with claim 29 wherein to automatically download a master list said computer configured to automatically download the master list via a web server to the web-based user interface.

32. A computer in accordance with claim 29 wherein to query the master list said computer configured to execute a light weight directory access protocol (LDAP).

33. A computer in accordance with claim 21 wherein said first business unit includes at least one engineering division and said second business unit includes at least one manufacturing division.

34. A computer in accordance with claim 21 wherein said first business unit includes at least one manufacturing division and said second business unit includes at least one marketing division.

35. A computer in accordance with claim 21 wherein said first business unit includes at least one engineering division and said second business unit includes at least one marketing division.

36. A computer configured to:
automatically download a master list when a user logs into a web-based user interface;
query the master list by executing a logic module to connect the user to a first server providing at least one of a consumption of a lower bandwidth and a faster user interface response than that of remaining servers; and
redirect user requests to the first server.

37. A computer in accordance with claim 36 wherein the logic module is a JAVA applet.

38. A computer in accordance with claim 36 wherein to automatically download a master list said computer configured to automatically download the master list via a web server to the web-based user.

39. A computer in accordance with claim 36 wherein to query the master list said computer configured to execute a light weight directory access protocol (LDAP).

40. A computer configured to:
execute a first change request that passes a first document through a first series of life cycle states;
execute a second change request that passes a second document through a second series of life cycle states; and
combine the first and second change requests to generate a third change request that passes a third document through a third series of life cycle states.

41. A computer in accordance with claim 40 wherein the first, second, and third change requests include requests for a change to data describing one of a part and an assembly of parts.

42. A computer in accordance with claim 40 wherein each of said first, second, and third series includes an initial state and a final state.
